(19) United States
(12) Patent Application Publication
(10) Pub. No.: US 2025/0355094 A1
(43) Pub. Date: Nov. 20, 2025

(54) SCANNING PROFILES WITH INTRA-SCAN TEMPORAL OPTIMIZATION FOR LIDAR SENSING

(71) Applicant: Microvision, Inc., Redmond, WA (US)

(72) Inventors: Rejin Joy, Redmond, WA (US); Prerit Pramod, Redmond, WA (US); Christopher Brian Adkins, Redmond, WA (US); Tim Niedermeyer, Redmond, WA (US); Jeremey Simpson, Redmond, WA (US); Jonathan Cross, Redmond, WA (US)

(73) Assignee: Microvision, Inc., Redmond, WA (US)

(21) Appl. No.: 19/058,634

(22) Filed: Feb. 20, 2025

Related U.S. Application Data
(60) Provisional application No. 63/648,882, filed on May 17, 2024.

(51) Int. Cl. G01S 7/4865; G01S 7/481; G01S 7/484; G01S 17/931

(52) U.S. Cl. CPC G01S 7/4865; G01S 7/4817; G01S 7/484; G01S 17/931

(57) ABSTRACT

Aspects of the subject disclosure may include, for example, a light detection and ranging system that includes a laser light source, scanning mirrors, light-sensitive devices, and time-of-flight measurement circuits. The angular velocity of the scanning mirrors is adjusted in a region of interest to modify resolution. A scanning mirror on a fast scan axis slows down entering the region and speeds up exiting, while a scanning mirror on a slow scan axis does the opposite. The system may also increase a laser pulse repetition rate in the region of interest for enhanced data acquisition. Other embodiments are disclosed.

### CROSS-REFERENCE TO RELATED APPLICATION(S)

The present application claims the benefit of priority to U.S. Provisional Application No. 63/648,882 filed on May 17, 2024, which is hereby incorporated herein by reference in its entirety.

### FIELD OF THE DISCLOSURE

The subject disclosure relates to light detection and ranging (LIDAR) systems that scan laser light pulses in a field of view.

### BACKGROUND

Systems that detect and measure distances to objects are widely used for various applications, including autonomous vehicles, robotics, and environmental mapping. These systems rely on scanning light pulses across a field of view to detect and measure distances to objects. The performance of these systems, measured by metrics such as accuracy, precision and efficiency, depend significantly on the scanning profiles and the motion of the mirrors used to direct the light pulses.

Traditional systems often employ linear or sinusoidal motion profiles for mirrors, which can limit the achievable resolution, and therefore the performance, of the system. Linear motion profiles typically result in uniform resolution across the scan, while sinusoidal motion profiles can lead to varying resolution, with faster motion near the center of the scan and slower motion at the edges.

### BRIEF DESCRIPTION OF THE DRAWINGS

Reference will now be made to the accompanying drawings, which are not necessarily drawn to scale, and wherein:

FIG. 1 shows a LIDAR system with scanning mirror assemblies in accordance with various aspects described herein;

FIG. 2 shows an automotive application of a LIDAR system with scanning mirror assemblies in accordance with various aspects described herein;

FIG. 3 shows a block diagram of a control logic in accordance with various aspects described herein;

FIG. 4 shows a scanning mirror assembly in accordance with various aspects described herein;

FIG. 5 shows a scanning mirror assembly without a mirror in accordance with various aspects described herein;

FIG. 6 shows a block diagram of transmit drive circuitry, scanning mirrors, and a laser module in accordance with various aspects described herein;

FIG. 7 shows a scanning pattern in a field of view that includes a region of interest in accordance with various aspects described herein;

FIGS. 8A and 8B show fast-scan and slow-scan trajectory components in accordance with various aspects described herein;

FIG. 9 shows an increased laser light pulse repetition rate in a region of interest in accordance with various aspects described herein;

FIG. 10 shows a side view of a transmit module in accordance with various aspects described herein;

FIG. 11 shows a top view of a transmit module in accordance with various aspects described herein;

FIG. 12 shows a side view of a receive module in accordance with various aspects described herein;

FIG. 13 shows a top view of a receive module in accordance with various aspects described herein;

FIG. 14 shows a perspective view of an integrated photonics module in accordance with various aspects described herein;

FIG. 15 shows a cross sectional top view of the integrated photonics module of FIG. 14; and

FIG. 16 depicts an illustrative embodiment of a method in accordance with various aspects described herein.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. Like numerals in the drawings refer to the same or similar functionality throughout the several views.

One or more aspects of the subject disclosure include a light detection and ranging system comprising a laser light source, at least one light-sensitive device, and at least one time-of-flight measurement circuit responsive to the light-sensitive device. The system further includes a first scanning mirror assembly to scan light received from the laser light source on a trajectory in a field of view, with the trajectory including a first trajectory component in a fast-scan direction and a second trajectory component in a slow-scan direction. The field of view includes a region of interest, where the second trajectory component speeds up entering the region of interest and slows down exiting the region of interest. Additionally, a second scanning mirror assembly synchronously scans with the first scanning mirror assembly to deposit reflected light energy from the field of view on the light-sensitive device.

One or more aspects of the subject disclosure include a system comprising a laser light source to emit laser light pulses in response to a laser light source control signal, a first scanning mirror to scan the laser light pulses on a fast-scan axis in a field of view in response to a first scanning mirror control signal, and a second scanning mirror to scan the laser light pulses on a slow-scan axis in the field of view in response to a second scanning mirror control signal. The system also includes drive circuitry to produce the laser light source control signal, the first scanning mirror control signal, and the second scanning mirror control signal. The field of view includes a region of interest, and the drive circuitry is configured to slow down the first scanning mirror when scanning in the region of interest.

One or more aspects of the subject disclosure include a method comprising: producing a pulsed beam of laser light; scanning the pulsed beam of laser light on a fast-scan axis in a field of view using a first scanning mirror, wherein the field of view includes a region of interest; scanning the pulsed beam of light on a slow-scan axis in the field of view using a second scanning mirror; decreasing an angular velocity of the first scanning mirror when scanning in the region of interest; and increasing a repetition rate of the pulsed beam of laser light when scanning in the region of interest.

Additional aspects of the subject disclosure include the light received from the laser light source comprising light pulses having a time difference therebetween, and wherein the time difference is smaller inside the region of interest than outside the region of interest, and/or the laser light source being responsive to a laser light control signal, and the laser light control signal causing the laser light source to increase a laser light pulse repetition rate inside the region of interest.

Additional aspects of the subject disclosure include the second trajectory component being slowest at an extents of the field of view, and/or the first scanning mirror assembly comprising a first scanning mirror responsive to a first drive signal to scan the light received from the laser light source in the fast-scan direction and a second scanning mirror responsive to a second drive signal to scan the light received from the laser light source in the slow-scan direction, and a control circuit to produce the first and second drive signals, where the control circuit includes a look up table to create the first drive signal or the second drive signal, or where the control circuit includes a circuit to sum harmonics to create the first drive signal.

Additional aspects of the subject disclosure include increasing an angular velocity of the second scanning mirror when scanning in the region of interest, where the angular velocity of the second scanning mirror is lowest at an extents of the field of view, and/or the region of interest being centered in the field of view.

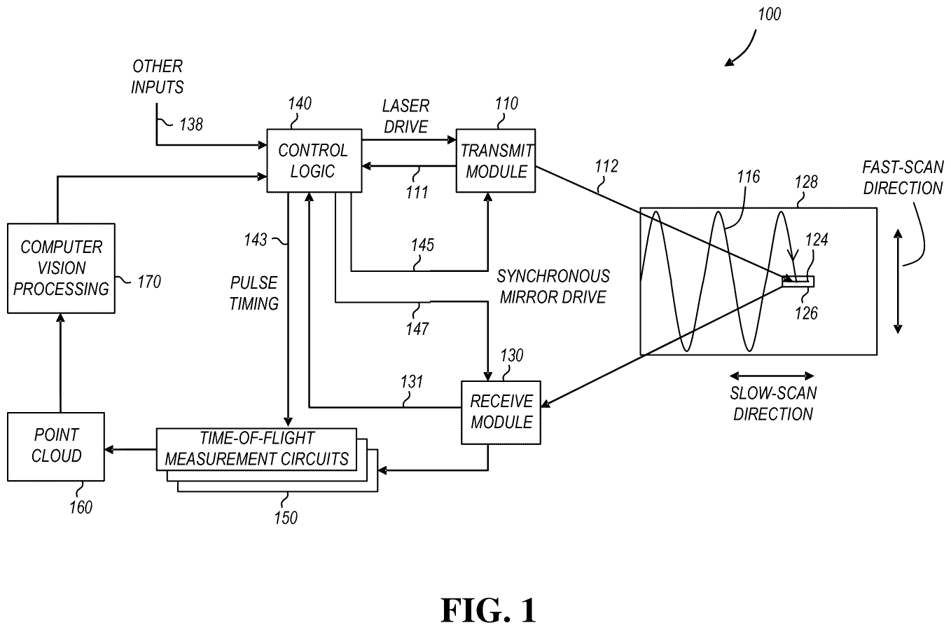

FIG. 1 shows a LIDAR system with scanning mirror assemblies in accordance with various aspects described herein. System 100 includes control circuit 140, transmit module 110, receive module 130, time-of-flight (TOF) measurement circuits 150, point cloud storage device 160, and computer vision processing 170.

Transmit module 110 emits a scanning pulsed laser beam 112 that traverses a field of view 128 in two dimensions. In some embodiments, the scanning pulsed laser beam is collimated into a point beam. Further, in some embodiments, the scanning pulsed laser beam 112 is a fanned beam. The shape of the fanned beam is shown at 124, and the scanning trajectory that the pulsed laser beam takes through the field of view is shown at 116. In some embodiments, to produce the scanning pulsed fanned beam, transmit module 110 includes a laser light source to produce a pulsed laser beam, collimating and focusing optics to shape the pulsed laser beam into a pulsed fanned laser beam, and one or more scanning mirror assemblies to scan the pulsed fanned laser beam in two dimensions in the field of view. Example embodiments of transmit modules are described more fully below with reference to later figures.

In some embodiments, receive module 130 includes an arrayed receiver that includes a plurality of light sensitive devices. Receive module 130 also includes optical devices and one or more scanning mirror assemblies to scan in two dimensions and to direct reflected light from the field of view to the arrayed receiver. As shown in FIG. 1, receive module 130 captures reflected light from an aperture 126 that encompasses the location of the fanned beam in the field of view. Example embodiments of receive modules are described more fully below with reference to later figures.

The reflected fanned beam becomes “discretized” by the array of light sensitive devices, and the corresponding points in the field of view from which the beam is reflected are referred to herein as “measurement points.”

As used herein, the term “fanned beam” refers to a beam of light that has been purposely shaped to encompass more measurement points in one dimension than in another dimension. For example, as shown in FIG. 1, fanned beam 112 includes shape 124 that encompasses more measurement points in the horizontal dimension than in the vertical dimension. Although fanned beam embodiments are further described below, the subject matter described herein is not limited to fanned beam embodiments. For example, in some embodiments, the scanning pulsed laser beam 112 may be a collimated beam that is not fanned in either dimension.

Time-of-flight (TOF) measurement circuits 150 are each coupled to one of the light sensitive devices in the arrayed receiver to measure a time-of-flight of a laser pulse. TOF measurement circuits 150 receive laser light pulse timing information 143 from control logic 140 and compare it to the timing of received laser light pulses to measure round trip times-of-flight of light pulses, thereby measuring the distance (Z) to the point in the field of view from which the laser light pulse was reflected. Accordingly, TOF measurement circuits 150 measure the distance between LIDAR system 100 and measurement points in the field of view at which light pulses from the scanned fanned beam are reflected.

TOF measurement circuits 150 may be implemented with any suitable circuit elements. For example, in some embodiments, TOF measurement circuits 150 include digital and/or analog timers, integrators, correlators, comparators, registers, adders, or the like to compare the timing of the reflected laser light pulses with the pulse timing information received from control logic 140.

Point cloud storage 160 receives TOF information corresponding to distance (Z) information from TOF measurement circuits 150. In some embodiments, the TOF measurements are held in point cloud storage 160 in an array format such that the location within point cloud storage 160 indicates the location within the field of view from which the measurement was taken. In other embodiments, the TOF measurements held in point cloud storage 160 include (X,Y) position information as well as TOF measurement information to yield (X,Y,Z) as a three dimensional (3D) data set that represents a depth map of the measured portion of the field of view 128. The point cloud data may then be used for any suitable purpose. Examples include 3D imaging, velocity field estimation, object recognition, adaptive field of view modifications, and the like.

Point cloud storage 160 may be implemented using any suitable circuit structure. For example, in some embodiments, point cloud storage 160 is implemented in a dual port memory device that can be written on one port and read on a second port. In other embodiments, point cloud storage 160 is implemented as data structures in a general purpose memory device. In still further embodiments, point cloud storage 160 is implemented in an application specific integrated circuit (ASIC).

Computer vision processing 170 performs analysis on the point cloud data and provides feedback to control logic 140. For example, in some embodiments, computer vision processing 170 performs object identification, classification, and tracking within the field of view, and provides this information to control logic 140. Computer vision processing 170 may take any form, including neural networks of any depth, convolutional neural nets, traditional vision processing methods, and the like. In some embodiments, computer vision processing 170 is omitted.

Control logic 140 determines laser drive properties and drives transmit module 110 with signal(s) that cause the light source to emit laser light pulses having the specified properties. For example, control logic 140 may determine values for laser drive power, pulse rate, pulse width, and number of multishot pulses. Further, control logic 140 may adaptively modify the laser drive properties in response to feedback from computer vision processing 170 or in response to other inputs 138.

Control logic 140 also controls the movement of scanning mirrors within transmit module 110 and receive module 130. In operation, control logic 140 receives mirror position feedback information 111 from transmit module 110, and also receives mirror position feedback information 131 from receive module 130. The mirror position feedback information is used to phase lock the operation of the mirrors. Control logic 140 drives microelectromechanical (MEMS) assemblies with scanning mirrors within transmit module 110 with drive signal(s) 145 and also drives MEMS assemblies with scanning mirrors within receive module 130 with drive signal(s) 147 that cause the mirrors to move non-resonantly through angular extents of mirror deflection with angular offsets that define the size and location of field of view 128. Control logic 140 synchronizes the movement between mirrors in transmit module 110 and receive module 130 so that area 126 is continually positioned in the field of view to receive light reflected from objects that are illuminated with pulsed fanned beam 112. The synchronization of transmit and receive scanning allows the receive aperture to only accept photons from the portion of the field of view where the transmitted energy was transmitted. This results in significant ambient light noise immunity.

Control logic 140 is implemented using functional circuits such as phase lock loops (PLLs), filters, adders, multipliers, registers, processors, memory, and the like. Accordingly, control logic 140 may be implemented in hardware, software, or in any combination. For example, in some embodiments, control logic 140 is implemented in an application specific integrated circuit (ASIC). Further, in some embodiments, some of the faster data path control is performed in an ASIC and overall control is software programmable.

As shown in FIG. 1, the two dimensional scanning is performed in a first dimension (vertical, fast scan direction) and a second dimension (horizontal, slow scan direction). The labels “vertical” and “horizontal” are somewhat arbitrary, since a 90 degree rotation of the apparatus will switch the horizontal and vertical axes. Accordingly, the terms “vertical” and “horizontal” are not meant to be limiting.

The scanning trajectory in the fast scan direction is shown as sinusoidal, and the scanning trajectory in the slow scan direction is shown as constant velocity, although this is not a limitation. In some embodiments, all mirror motion is operated non resonantly. Accordingly, a relatively flat control band exists down to and including 0 Hz. This allows a drive signal to be generated to cause the pointing angle (boresight) of the LIDAR system to deflect to a desired position in two dimensions (azimuth & elevation) of a spherical coordinate space, offset from the mirror relaxation point.

The angular extents of mirror deflection of both the transmit and receive modules can be adjusted to change the active field of view of the LIDAR system. The scanning mirror assemblies are designed for reliable operation at some maximum angle of deflection along each scan axis. From that nominal/max operating point, the drive amplitude may be reduced to collapse the deflection angle and narrow the active field of view. All else being equal, this results in a proportional increase in the angular resolution of the acquired scene.

In some embodiments, it is beneficial to trade off surplus angular resolution for increased range of measurement. For example, reducing the pulse repetition rate allows for a longer flight time in between adjacent pulses, eliminating range aliasing out to a proportionally larger distance. Accordingly, a balance exists such that reducing the field of view increases the non-ambiguous range of the LIDAR system without changing the angular resolution of the acquired scene. In some embodiments, laser power modifications are performed as a complement to increased range. For example, the laser power may be scaled as the square of the proportional increase in range.

Though the scanned field of view, pulse repetition rate, and laser power may all be independently controlled by software configuration, in some embodiments, it may be desirable to also design them to be commanded in a coordinated manner, automatically under hardware control.

Pulse width may also be controlled in the same manner in order to augment the scaled distance of interest. As the pulse width is increased, additional energy is deposited into the scene, increasing the likelihood of a sufficient number of photons returning to the receiver to trip the detection threshold. In some embodiments, increasing the pulse width is only performed when the peak power is maxed out as a wider pulse increases time resolution error for weak returns. This tradeoff is often warranted and useful as absolute time/distance resolution is typically not as important as percentage error which self-normalizes with distance.

Pulse energy may also be augmented by means of a train of shorter multishot pulses. The number of pulses may be varied to achieve the desired amount of energy in addition to or in place of modification of the pulse width.

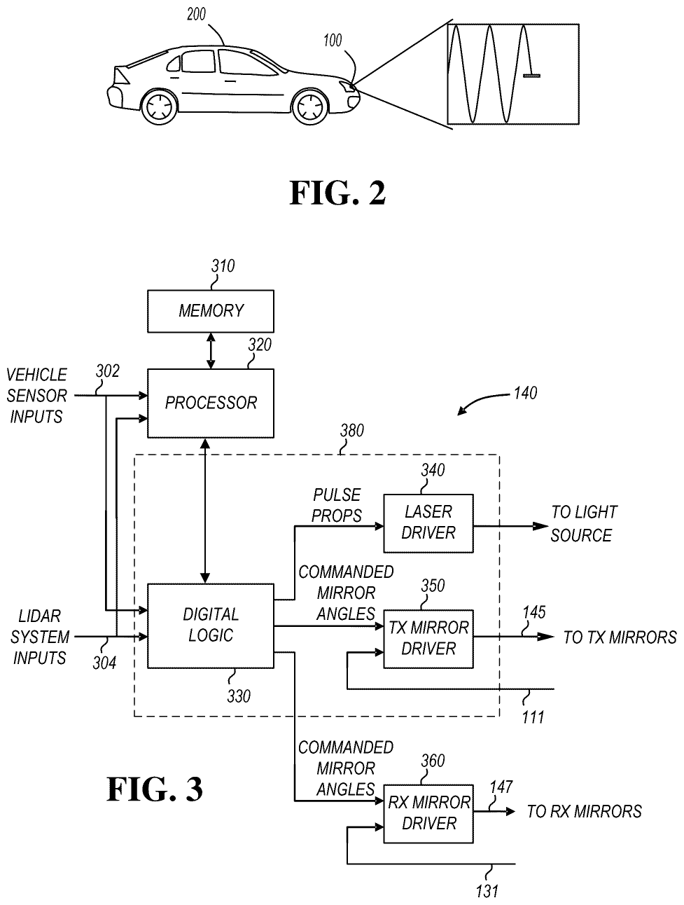

FIG. 2 shows an automotive application of a LIDAR system with scanning mirror assemblies in accordance with various aspects described herein. As shown in FIG. 2, vehicle 200 includes LIDAR system 100 at the front of the vehicle. LIDAR system 100 synchronously scans transmit and receive scanning mirrors such that receiver aperture 126 substantially overlaps the shape 124 of the pulsed fanned beam. Although much of the remainder of this description describes the LIDAR system in the context of an automotive application, the various embodiments described herein are not limited in this respect.

FIG. 3 shows a block diagram of a control logic in accordance with various aspects described herein. The example embodiment shown in FIG. 3 corresponds to a control logic that may be included when LIDAR system 100 is used in an automotive application. Other control logic embodiments may be employed when used in applications other than automotive applications. Control logic 140 includes processor 320, memory 310, transmit control circuitry 380, and receive mirror driver 360. Transmit drive circuitry includes digital logic 330, laser driver 340, and transmit mirror driver 350. Control logic 140 receives vehicle sensor inputs at 302 and LIDAR system inputs at 304. Vehicle sensor inputs may include any type of data produced by sensors on a vehicle. Examples include data describing vehicle position, speed, acceleration, direction. Other examples include sensor data received from adaptive driver assistance systems (ADAS) or other vehicle mounted sensors. LIDAR system inputs may include any data gathered or produced by the LIDAR system. Examples include computer vision processing results, internal inertial measurement unit data, and the like.

Processor 320 may include any type of processor capable of executing instructions stored in a memory device. For example, processor 320 may be a microprocessor, a digital signal processor, or a microcontroller. Processor 320 may also be a hard-coded processor such as a finite state machine that provides sequential flow control without fetching and executing instructions.

Memory 310 may be any device that stores data and/or processor instructions. For example, memory 310 may be a random access memory device that stores data. In some embodiments, memory 310 is a non-transitory storage device that stores instructions, that when accessed by processor 320 result in processor 320 performing actions. For example, in some embodiments, processor 320 executes instructions stored in memory 310 and performs method embodiments.

Digital logic 330 receives vehicle sensor inputs at 302 and LIDAR system inputs at 304 and outputs information used to control a laser light source and scanning mirrors. Digital logic 330 may produce the outputs based solely on the vehicle sensor data and/or LIDAR system data, may produce the outputs based solely on interactions with processor 320, or may produce the outputs based on a combination of the vehicle sensor data, LIDAR system data, and interaction with processor 320. For example, in some embodiments, digital logic 330 modifies laser light pulse parameters such as pulse power, repetition rate, pulse width, and number of multishot pulses in response to vehicle sensor data and/or LIDAR system data. Also for example, in some embodiments, digital logic 330 modifies angular extents and angular offsets used to drive the scanning mirrors in the transmit module and receive module in response to vehicle sensor data and/or LIDAR system data.

In some embodiments, digital logic 330 provides output data under software control via interaction with processor 320. For example, processor 320 may determine values for any of the outputs in response to vehicle sensor data and/or LIDAR system data, and then command digital logic under software control. In other embodiments, digital logic 330 may provide output data under hardware control independent of processor 320. For example, an adaptive model may be programmed into digital logic 330 in advance, and digital logic 330 may then modify outputs as a function vehicle sensor data and/or LIDAR system data at a much faster rate.

Laser driver 340 receives laser light properties from digital logic 330 and drives the laser light source. For example, laser driver 340 may receive property values for pulse power, pulse repetition rate, pulse width, and number of multishot pulses, and produce an analog signal to drive a laser light source. Laser driver 340 may be implemented with any suitable circuit elements including for example, high speed signal generators, amplifiers, filters, and the like.

Mirror drivers 350, 360 receive commanded mirror angle information from digital logic 330 and mirror position feedback information 111, 131, and produce drive signals 145, 147 to cause scanning mirrors in modules 110, 130 to undergo motion. Transmit mirror driver 350 and receive mirror driver 360 may be implemented using any suitable circuit structures including for example, phase lock loops, numerically controlled oscillators, filters, amplifiers, and the like. In some embodiments, mirror position feedback information 111, 131 includes measured mirror angle information as well as measured temperature information. Mirror drivers use the measured temperature information to compensate for angle measurement errors as a function of temperature. These and other embodiments are further described below.

As described further below, in some embodiments, digital logic 330 drives mirror drivers 350 and 360 with signals that control scan trajectory components on the fast scan axis and the slow scan axis. In some embodiments, the scan trajectory component on the slow scan axis is slowest at the horizontal extents of the field of view and is fastest at the center of the horizontal field of view. Also in some embodiments, the scan trajectory component on the fast scan axis slows down near the center of the vertical field of view, and speeds up as it moves away from the center of the field of view. In some embodiments, a region of interest is defined in the field of view within which the scan trajectory component on the slow scan axis speeds up and the scan trajectory component on the fast scan axis slows down. These and other embodiments are further described below.

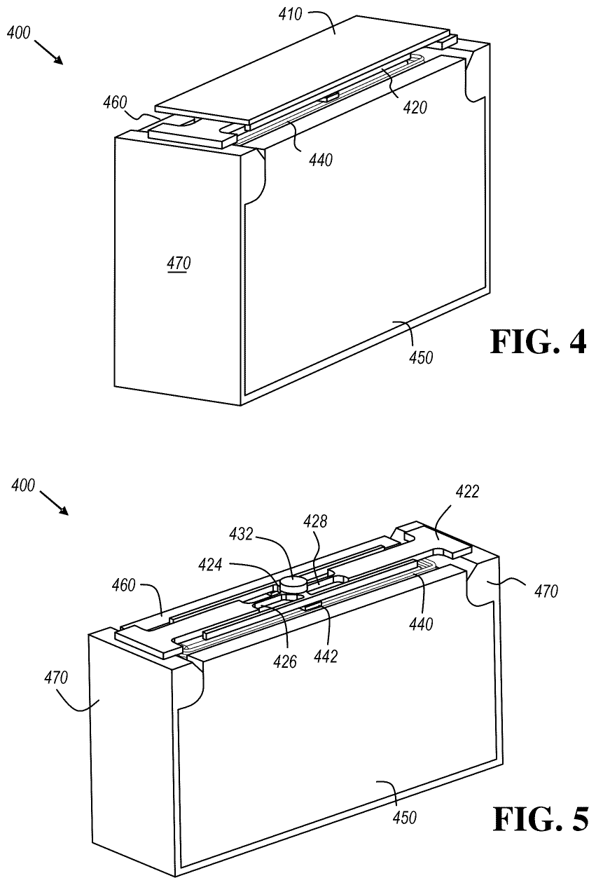

FIG. 4 shows a scanning mirror assembly and FIG. 5 shows the scanning mirror assembly with the mirror removed in accordance with various aspects described herein. Scanning mirror assembly 400 may be used to implement any of the scanning mirror assemblies described herein. For example, any of scanning mirror assemblies 1030, 1040, 1230, and 1240 described below may be implemented with scanning mirror assembly 400.

Scanning mirror assembly 400 includes mirror 410, Microelectromechanical system (MEMS) device 420, conductive coil 440, magnetically permeable components 450, 460, and housing 470. MEMS device 420 includes fixed platforms 422 and scanning platform 424. Scanning platform 424 is coupled to fixed platforms 422 by flexures 426, 428. Mirror 410 is affixed to scanning platform 424 by adhesive 432. Fixed platforms 422 are affixed to housing 470.

The axis of flexures 426, 428 forms a pivot axis. Flexures 426, 428 are flexible members that undergo a torsional flexure, also referred to herein as torsional movement, thereby allowing scanning platform 424 to rotate on the pivot axis and have an angular displacement relative to fixed platforms 422. Flexures 426, 428 are not limited to torsional embodiments as shown in FIG. 5. For example, in some embodiments, flexures 426, 428 take on other shapes such as arcs, “S” shapes, or other serpentine shapes.

MEMS device 420 also incorporates a plurality of piezoresistive strain sensors. In some embodiments, the plurality of piezoresistive strain sensors are positioned on or near one of flexures 426, 428 to produce a voltage that represents the angular displacement of scanning platform 424 with respect to fixed platforms 422. The piezoresistive sensor(s) are coupled to electrical contacts (not shown) on fixed platforms 422 so that position feedback signal(s) may be provided to control logic 140 (FIGS. 1, 3).

Much of MEMS device 420 can be fabricated from a single common substrate using MEMS techniques. For example, the fixed platforms 422, the scanning platform 424 and the two flexures 426, 428 can all be formed from the same substrate. Additionally, in some embodiments, conductive signal traces, contacts, and piezoresistive strain sensors can also be formed with any suitable MEMS technique. For example, the signal traces, contacts, and piezoresistive strain sensors can be formed by the selective deposition and patterning of conductive materials on the substrate.

Scanning mirror assembly 400 also includes a conductive coil 440 affixed to the underside of scanning platform 424 by adhesive 442. In operation, a current is induced in conductive coil 440 to create a magnetic field. The interaction of the magnetic field produced by conductive coil 440 with a magnetic field produced by one or more permanent magnets (not shown in FIGS. 4, 5) creates Lorentz forces on scanning platform 424 and results in an angular displacement of mirror 410 as a function of drive current in conductive coil 440.

Housing 470 may be made of any suitable material. For example, in some embodiments, housing 470 is plastic. Fixed platforms 422 may be affixed to housing 470 using any suitable technique, including fasteners or adhesive.

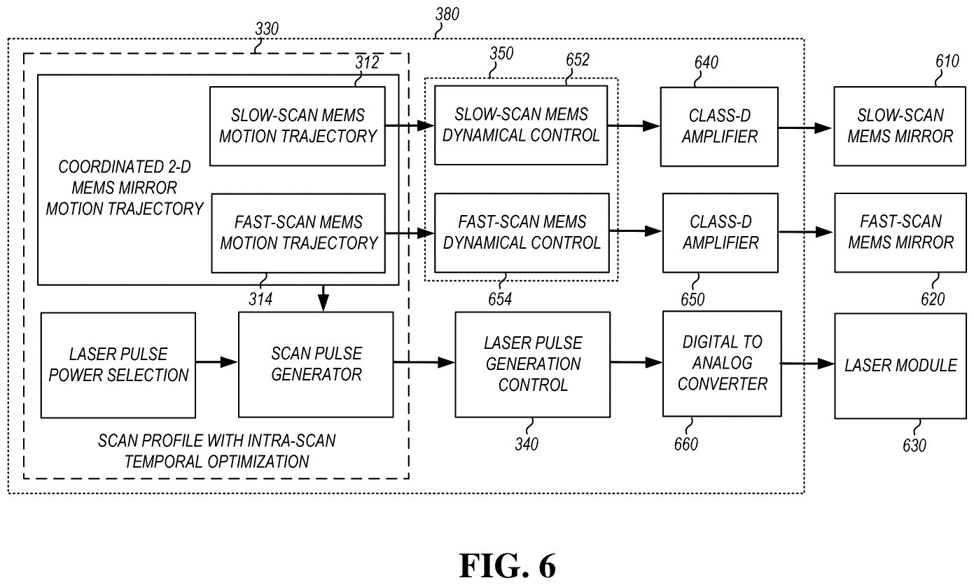

FIG. 6 shows a block diagram of transmit drive circuitry, scanning mirrors, and a laser module in accordance with various aspects described herein. The transmit drive circuitry 380 is responsible for generating the 2-dimensional MEMS mirror motion trajectory, which includes both the horizontal mirror motion trajectory and the vertical mirror motion trajectory. Various embodiments produce scan trajectories that enhance the resolution LiDAR system.

Slow-scan MEMS mirror 610 reflects laser light pulses received from laser module 630 and scans the received laser light pulses on a slow scan axis. Similarly, fast-scan MEMS mirror 620 reflects the laser light pulses and scans the received laser light pulses on a fast scan axis. In some embodiments, slow-scan MEMS mirror 610 reflects laser light pulses received from laser module 630, and fast-scan MEMS mirror 620 reflects laser light pulses received from slow-scan MEMS mirror 610. In other embodiments, fast-scan MEMS mirror 620 reflects laser light pulses received from laser module 630, and slow-scan MEMS mirror 610 reflects laser light pulses received from fast-scan MEMS mirror 620. Slow-scan MEMS mirror 610 and fast-scan MEMS mirror 620 may be implemented using any suitable MEMS mirror design, including for example, scanning mirror assembly 400 (FIGS. 4, 5).

Transmit mirror driver 350 includes slow-scan MEMS dynamical control 652 and fast-scan MEMS dynamical control 654. The slow-scan MEMS mirror 610 and the fast-scan MEMS mirror 620 are driven by the slow-scan MEMS dynamical control 652 and the fast-scan MEMS dynamical control 654, respectively. These controls receive digital signals from the digital logic 330 and convert them into analog signals to drive the MEMS mirrors. In some embodiments, the slow-scan mirror motion trajectory is designed to increase the angular velocity of slow-scan MEMS mirror 610 when entering the region of interest, thereby increasing the slow scan trajectory component when entering the region of interest and is designed to decrease the angular velocity of slow-scan MEMS mirror 610 when exiting the region of interest. Conversely, the fast-scan mirror motion trajectory is designed to decrease the angular velocity of fast-scan MEMS mirror 620 when entering the region of interest, thereby decreasing the fast scan trajectory component when entering the region of interest and is designed to increase the angular velocity of fast-scan MEMS mirror 620 when exiting the region of interest.

The laser module 630 generates laser light pulses in response to a drive signal received from laser driver 340. Laser driver 340 produces the drive signal in response to control signal(s) received from digital logic 330. In some embodiments, the laser light pulses are generated at a higher repetition rate when the scan trajectory is within the region of interest. For example, when the scan trajectory is outside the region of interest, the laser light pulse repetition may take on a first value, and when the scan trajectory is inside the region of interest, the laser light pulse repetition may take on a second value that is higher than the first value. In some embodiments, the increased laser light pulse repetition rate when scanning within the region of interest enhances the resolution and data acquisition in that area.

In some embodiments, the region of interest in the field of view is centered and is where the system focuses on obtaining higher resolution data. The digital logic 330 ensures that the fast scan trajectory component decreases in velocity when entering this region and increases when exiting, while the slow scan trajectory component increases in velocity when entering and decreases when exiting. This coordinated control of the MEMS mirrors and laser pulses allows for optimized scanning profiles with intra-scan temporal optimization, improving the resolution of the LiDAR system.

In some embodiments, one or more of the slow-scan mirror motion trajectory 312 and the fast-scan mirror motion trajectory 314 are generated using a look up table. For example, the desired trajectory may be represented as a sequence of discrete points that are stored in a memory device (look up table) and the contents are read out in sequence and converted to analog form by transmit mirror driver 350. In other embodiments, one or more of the slow-scan mirror motion trajectory 312 and the fast-scan mirror motion trajectory 314 are generated by summing sinusoidal signals. For example, in some embodiments, odd harmonics are summed with a fundamental to create the fast scan and/or slow scan trajectory component.

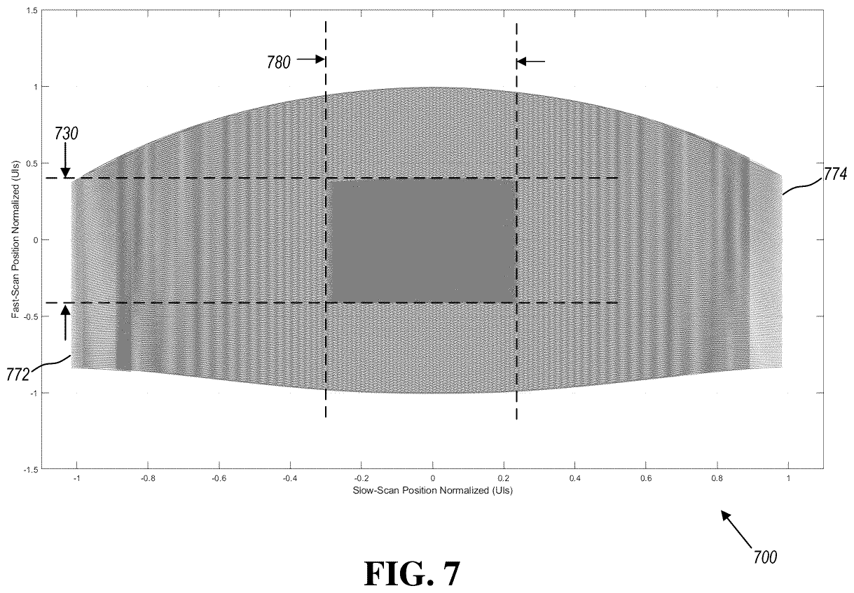

FIG. 7 shows a scanning pattern in a field of view that includes a region of interest in accordance with various aspects described herein. The figure shows the two dimensional region of interest bounded by the fast-scan trajectory component in the region of interest 730 and the slow-scan trajectory component in the region of interest 780. In some embodiments, the region of interest bounded by 730, 780 is centered within the field of view 900, and in other embodiments, the region of interest is not centered within the field of view 700. In some embodiments, the fast-scan trajectory component decreases in velocity when entering the region of interest and increases when exiting the region of interest, allowing for more detailed data acquisition. Conversely, in some embodiments, the slow-scan trajectory component increases in velocity when entering the region of interest and decreases when exiting the region of interest, further optimizing the resolution of the LiDAR system.

By carefully controlling the speed at which the mirrors move and the repetition rate of the laser light pulses, the system can achieve higher resolution in regions of interest. In the region of interest, the fast-scan trajectory component decreases in velocity when entering and increases when exiting. This reduction in speed allows the system to spend more time scanning this area, thereby capturing more detailed data and improving the resolution. Conversely, the slow-scan trajectory component increases in velocity when entering the region of interest and decreases when exiting. This coordinated control ensures that the system can focus on obtaining high-resolution data in the most important areas.

Outside the region of interest, the fast-scan trajectory component increases in velocity, and the slow-scan trajectory component decreases in velocity. This allows the system to cover the rest of the field of view more quickly, maintaining efficient scanning without compromising the overall performance.

Additionally, the slow-scan trajectory component is slowest at the extents of the field of view, indicated by points 772 and 774. This controlled variation in velocity helps to distribute the thermal load more evenly over time. By reducing the speed at the edges, the system can prevent excessive heating in any one area, thereby improving the thermal management of the LiDAR system.

Overall, the change in angular velocity of the MEMS scanning mirrors allows the LiDAR system to balance the need for high-resolution imaging in some areas with the need for efficient scanning. This results in a more robust and reliable system capable of delivering accurate and detailed data in a variety of applications.

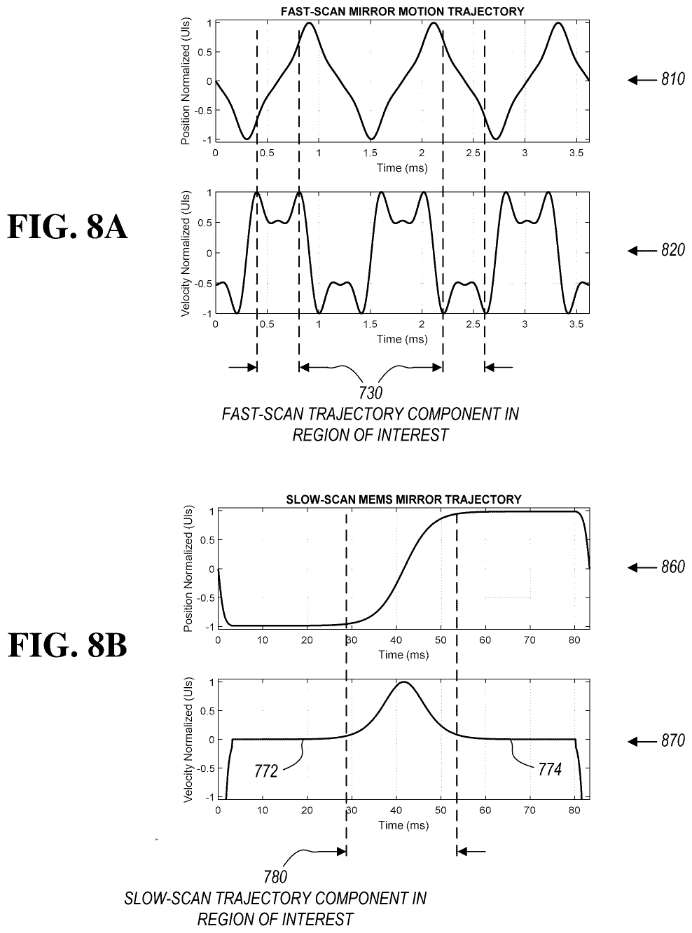

FIGS. 8A and 8B show fast-scan and slow-scan trajectory components in accordance with various aspects described herein. The figure includes two plots: the top plot 810 shows the position of the fast-scan MEMS mirror over time, while the bottom plot 820 shows the corresponding velocity of the fast-scan MEMS mirror over the same time period. In the top plot 810, the fast-scan MEMS mirror position 710 is normalized and plotted against time. The trajectory demonstrates how the mirror's position changes as it scans the laser light pulses through the field of view. The region of interest is highlighted at 730, showing where the system focuses on obtaining higher resolution data. Within this region, the position trajectory is designed to slow down, allowing for more detailed data acquisition.

In the bottom plot 820, the fast-scan MEMS mirror motion velocity is also normalized and plotted against time. This plot illustrates how the velocity of the fast-scan MEMS mirror changes as it enters and exits the region of interest. Specifically, the fast-scan trajectory component shows an increase in velocity when entering the region of interest 730 and a decrease in velocity when exiting the region of interest 730. This controlled variation in velocity helps optimize the resolution of the LiDAR system by allowing more time for data acquisition in critical areas while maintaining efficient scanning elsewhere.

FIG. 8B illustrates the slow-scan MEMS mirror motion trajectory. The figure includes two plots: the top plot 860 shows the position of the slow-scan MEMS mirror over time, while the bottom plot 870 shows the corresponding velocity of the slow-scan MEMS mirror over the same time period.

In the top plot 860, the slow-scan MEMS mirror position is normalized and plotted against time. The trajectory demonstrates how the mirror's position changes as it scans the laser light pulses through the field of view. The region of interest 780 is highlighted, showing where the system focuses on obtaining higher resolution data. Within this region, the slow scan position trajectory is designed to slow down, allowing for more detailed data acquisition.

In the bottom plot 870, the slow-scan MEMS mirror motion velocity is also normalized and plotted against time. This plot illustrates how the velocity of the slow-scan MEMS mirror changes as it enters and exits the region of interest. Specifically, the slow scan trajectory component speeds up when entering the region of interest 780 and slows down when exiting the region of interest 780. Additionally, the slow scan trajectory component is slowest at the extents of the field of view, indicated by points 772 and 774. This controlled variation in velocity helps optimize the resolution of the LiDAR system by allowing more time for data acquisition in critical areas while maintaining efficient scanning elsewhere.

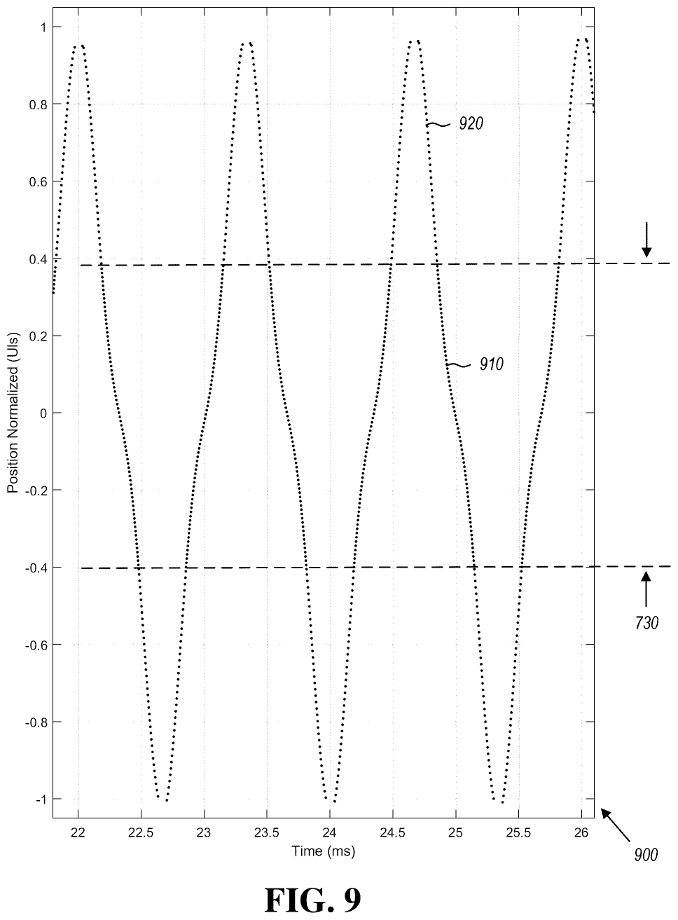

FIG. 9 shows an increased laser light pulse repetition rate in a region of interest in accordance with various aspects described herein. The figure shows the fast-scan trajectory component 900, which represents the motion of the fast-scan MEMS mirror as it scans through the field of view. The trajectory is depicted with a series of peaks and troughs, indicating the angular motion of the mirror. The laser light pulses 920 are shown as dots along the fast scan trajectory, indicating the points in time when the laser emits pulses. The increased laser light pulse repetition rate 910 is evident in the region of interest, where the density of the laser light pulses is higher compared to other regions. This higher density of pulses allows for enhanced resolution and more detailed data acquisition within the region of interest.

In some embodiments, the control logic of the LiDAR system modulates the laser light pulse repetition rate to increase when scanning within the region of interest. This modulation ensures that more laser pulses are emitted in this area, improving the overall performance and accuracy of the LiDAR system by providing finer resolution and better data quality where it is desired.

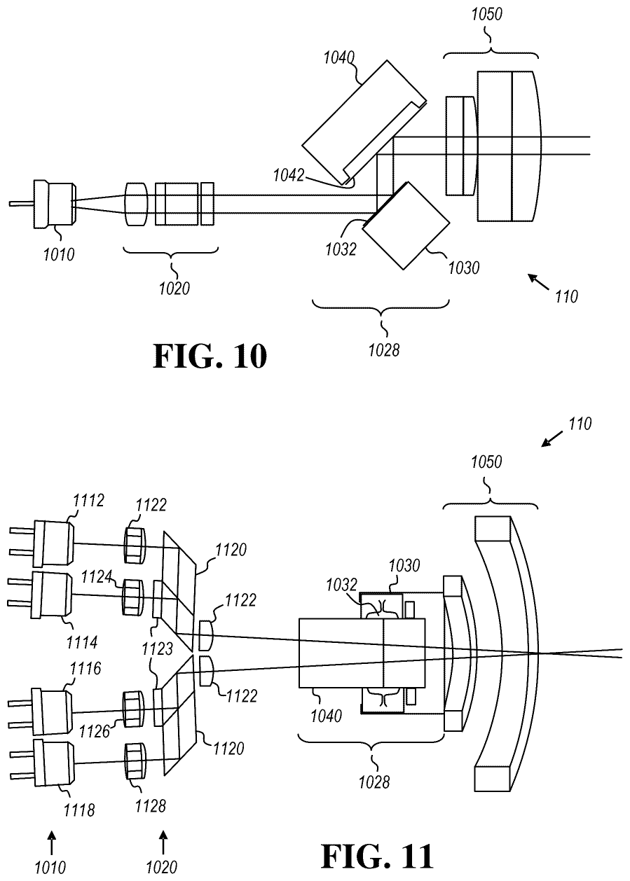

FIG. 10 shows a side view and FIG. 11 shows a top view of a transmit module in accordance with various aspects described herein. Transmit module 110 includes laser light source 1010, beam shaping optical devices 1020, scanner 1028, and exit optical devices 1050.

In some embodiments, laser light source 1010 sources nonvisible light such as infrared (IR) light. In these embodiments, the receive module 130 (FIG. 1) is able to detect the same wavelength of nonvisible light. For example, in some embodiments, light source 1010 may include a laser diode that produces infrared light with a wavelength of substantially 905 nanometers (nm), and receive module 130 detects reflected light pulses with a wavelength of substantially 905 nm. Also for example, in some embodiments, light source 1010 may include a laser diode that produces infrared light with a wavelength of substantially 940 nanometers (nm) and receive module 130 detects reflected light pulses with a wavelength of substantially 940 nm. The wavelength of light is not a limitation of the various embodiments. Any wavelength, visible or nonvisible, may be used without departing from the scope of the various embodiments described herein.

Laser light source 1010 may include any number or type of emitter suitable to produce a pulsed fanned laser beam. For example, in some embodiments, laser light source 1010 includes multiple laser diodes shown in FIG. 11 at 1112, 1114, 1116, and 1118. In some embodiments, the pulsed laser light produced by laser light source 1010 is combined, collimated, and focused by beam shaping optical devices 1020 to produce a pulsed fanned laser beam. For example, optical devices 1122 may collimate the laser beams on the fast axis, polarization rotators 1123 and beam combiners 1120 may combine laser beams, and optical devices 1122 may form the pulsed laser beam into a fan on the slow axis. In some embodiments, the pulsed laser beam may be focused to form the fanned beam, and in other embodiments, the pulsed laser beam may be expanded to form the fanned beam. In some embodiments, optical devices 1122 may be line generator optics to form the pulsed laser beam into a fanned beam. In some embodiments, the pulsed laser beam may be collimated on the fast axis with <0.2 degrees of divergence and may be focused or expanded on the slow axis to diverge at a rate that produces a fan of substantially four degrees. Beam sizes and divergence values are not necessarily uniform across the various embodiments described herein; some embodiments have higher values, and some embodiments have lower values.

Scanner 1028 receives the pulsed fanned laser beam from optical devices 1020 and scans the pulsed fanned beam in two dimensions. In embodiments represented by FIGS. 10 and 11, scanner 1028 includes two separate scanning mirror assemblies 1030, 1040, each including a scanning mirror 1032, 1042, where each scanning mirror scans the beam in one dimension. For example, scanning mirror 1032 scans the pulsed fanned beam in the fast scan direction, and scanning mirror 1042 scans the pulsed fanned beam in the slow scan direction.

Scanning mirror assemblies 1030, 1040 are driven by signals received from control logic 140 (FIGS. 1, 3). For example, scanning mirror 1032 may scan in one dimension according to a first commanded angle on the first dimension as a result of being driven by a first control signal, and scanning mirror 1042 may scan in a second dimension according to a second commanded angle on the second dimension as a result of being driven by a second control signal. In some embodiments, the instantaneous angular deflection of scanning mirror assemblies 1030 and 1040 are independently controlled, resulting in a completely configurable field of view along with configurable scan rates.

Although scanner 1028 is shown including two scanning mirror assemblies, where each scans in a separate dimension, this is not a limitation of the various embodiments described herein. For example, in some embodiments, scanner 1028 is implemented using a single biaxial scanning mirror assembly that scans in two dimensions. In some embodiments, scanning devices uses electromagnetic actuation, achieved using a miniature assembly containing a MEMS die and small subassemblies of permanent magnets and an electrical interface, although the various embodiments are not limited in this respect.

Exit optical devices 1050 operate on the scanning pulsed fanned laser beam as it leaves the transmit module. In some embodiments, exit optical devices 1050 perform field expansion. For example, scanning mirror assembly 1028 may scan through maximum angular extents of 20 degrees on the fast scan axis, and may scan through maximum angular extents of 40 degrees on the slow scan axis, and exit optical devices 1050 may expand the field of view to 30 degrees on the fast scan axis and 120 degrees on the slow scan axis. The relationship between scan angles of scanning mirrors and the amount of field expansion provided by exit optical devices 1050 is not a limitation of the various embodiments described herein.

In some embodiments, laser diodes 1112, 1114, 1116, and 1118 are high power multimode laser diodes. Multimode laser diodes typically have relatively large emitter areas that result in a beam that diverges faster on one axis than on the other axis. For example, an example 905 nm multimode laser diode may have a 10 um emitter on the fast axis and a 220 um emitter on the slow axis resulting in an emitted beam that inherently diverges faster on the slow axis. Various embodiments take advantage of this non-uniform beam shape by collimating the beam on the axis that naturally diverges more slowly, and focusing the beam into a fan on the axis that naturally diverges more quickly.

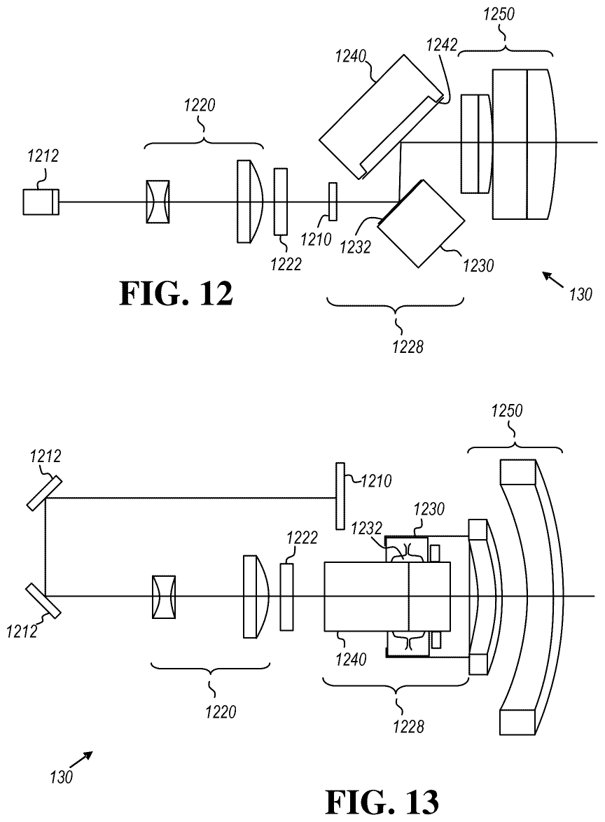

FIG. 12 shows a side view and FIG. 13 shows a top view of a receive module in accordance with various aspects described herein. Receive module 130 includes arrayed receiver 1210, fold mirrors 1212, imaging optical devices 1220, bandpass filter 1222, scanner 1228, and exit optical devices 1250.

Scanning mirror assemblies 1230 and 1240 are similar or identical to scanning mirror assemblies 1030 and 1040, and exit optical devices 1250 are similar or identical to exit optical devices 1050. Bandpass filter 1222 passes the wavelength of light that is produced by laser light source 1010 and blocks ambient light of other wavelengths. For example, in some embodiments, laser light source produces light at 905 nm, and bandpass filter 1222 passes light at 905 nm.

Imaging optical devices 1220 image a portion of the field of view onto arrayed receiver 1210 after reflection by fold mirrors 1212. For example, in some embodiments, optical devices 1220 image the area 126 (FIG. 1) onto arrayed receiver 1210. Because scanner 1228 is scanned synchronously with scanner 1028, arrayed receiver 1210 always collects light from the measurement points illuminated by the scanned pulsed fanned beam.

Arrayed receiver 1210 includes an array of light sensitive devices. The array of light sensitive devices may be one-dimensional or two-dimensional. For example, in some embodiments, arrayed receiver 1210 includes a 1×M array of PIN photodiodes, Silicon photomultipliers (SiPM), avalanche photodiodes (APD), or the like, where M is any integer. Also for example, in some embodiments, arrayed receiver 1210 includes a N×M array of PIN photodiodes, Silicon photomultipliers (SiPM), avalanche photodiodes (APD), or the like, where N and M are any integers. Any number of light sensitive devices may be included without departing from the scope of the various embodiments described herein. For example, in some embodiments, 16 light sensitive devices are included, and in other embodiments, 24 light sensitive devices are included.

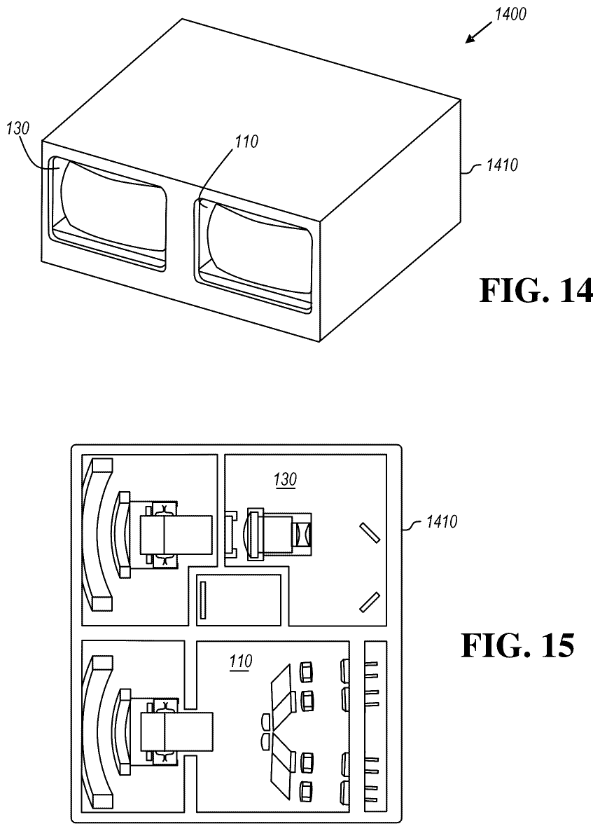

FIG. 14 shows a perspective view of an integrated photonics module in accordance with various embodiments described herein. Integrated photonics module 1400 is shown having a rectangular housing 1410 with transmit module 110 and receive module 130 placed side by side. In some embodiments, transmit module 110 and receive module 130 are placed one on top of the other. The relative orientation of transmit module 110 and receive module 130 is not a limitation of the various embodiments described herein.

FIG. 15 shows a cross sectional top view of the integrated photonics module of FIG. 14. Transmit module 110 and receive module 130 are shown side by side. In some embodiments, space is provided for electronics above and below the rearmost optical devices in integrated photonics module 1400. Any amount of system electronics may be included within module 1400. For example, in some embodiments, all components shown in FIG. 1 are included in module 1400. Also for example, in some embodiments, only control logics and TOF measurement circuits are included in module 1400.

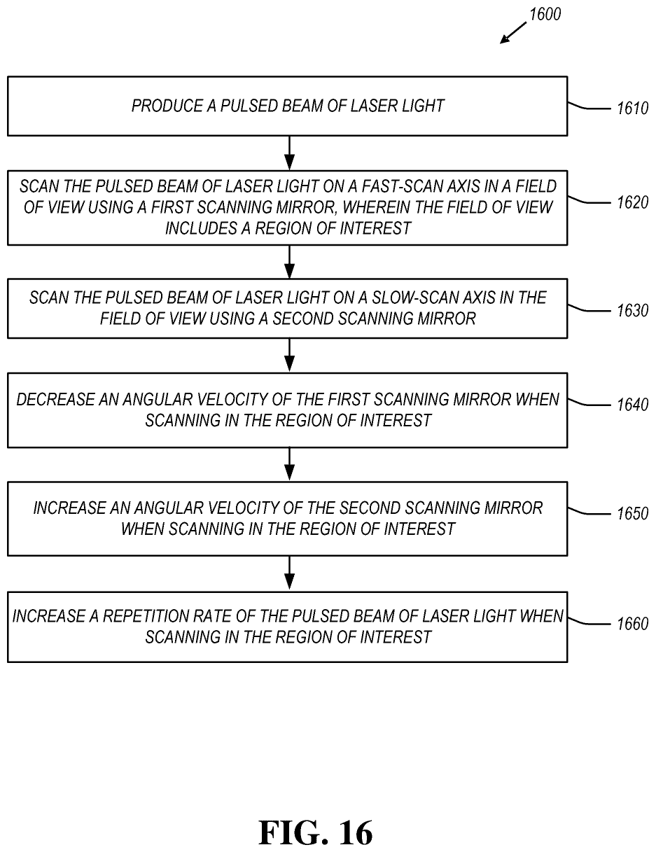

FIG. 16 shows a flow diagram of methods in accordance with various aspects described herein. In some embodiments, method 1600, or portions thereof, is performed by a MEMS system, a scanning LIDAR system, or a scanning LIDAR module. In other embodiments, method 1600 is performed by a series of circuits or an electronic system. Method 1600 is not limited by the particular type of apparatus performing the method. The various actions in method 1600 may be performed in the order presented or may be performed in a different order. Further, in some embodiments, some actions listed in FIG. 16 are omitted from method 1600.

Method 1600 is shown beginning with block 1610 in which a pulsed beam of laser light is produced. In some embodiments, the actions of block 1610 may be performed by a laser module that generates laser light pulses in response to a drive signal. For example, the laser module 630 generates laser light pulses in response to a drive signal received from laser driver 340. Laser driver 340 produces the drive signal in response to control signal(s) received from digital logic 330. In some embodiments, the laser light pulses are generated at a higher repetition rate when the scan trajectory is within the region of interest. For example, when the scan trajectory is outside the region of interest, the laser light pulse repetition may take on a first value, and when the scan trajectory is inside the region of interest, the laser light pulse repetition may take on a second value that is higher than the first value. In some embodiments, the increased laser light pulse repetition rate when scanning within the region of interest enhances the resolution and data acquisition in that area.

At 1620, the pulsed beam of laser light is scanned on a fast-scan axis in a field of view using a first scanning mirror. In some embodiments, the actions of block 1620 may be performed by a fast-scan MEMS mirror that varies in angular velocity to scan the pulsed beam of laser light on a fast scan axis. For example, the fast-scan MEMS mirror 620 reflects the laser light pulses and scans the received laser light pulses on a fast scan trajectory component. In some embodiments, fast-scan MEMS mirror 620 reflects laser light pulses received from laser module 630, and slow-scan MEMS mirror 610 reflects laser light pulses received from fast-scan MEMS mirror 620. The fast-scan MEMS mirror 620 is driven by the fast-scan MEMS dynamical control 654, which receives digital signals from the digital logic 330 and converts them into analog signals to drive the MEMS mirrors.

At 1630 the pulsed beam of laser light is scanned on a slow-scan axis in the field of view using a second scanning mirror. In some embodiments, the actions of block 1630 may be performed by a slow-scan MEMS mirror that moves to scan the laser light on a slow scan axis. For example, the slow-scan MEMS mirror 610 reflects laser light pulses received from laser module 630 and scans the received laser light pulses on a slow scan trajectory component. In some embodiments, slow-scan MEMS mirror 610 reflects laser light pulses received from fast-scan MEMS mirror 620. The slow-scan MEMS mirror 610 is driven by the slow-scan MEMS dynamical control 652, which receives digital signals from the digital logic 330 and converts them into analog signals to drive the MEMS mirrors.

At 1640, an angular velocity of the first scanning mirror is decreased when scanning in the region of interest. In some embodiments, the actions of block 1640 may be performed by adjusting the control signals to the fast-scan MEMS mirror. For example, the control logic 140 may modify the drive signal waveform to slow down the mirror's motion in the region of interest. The fast-scan mirror motion trajectory is designed to decrease the angular velocity of fast-scan MEMS mirror 620 when entering the region of interest, thereby decreasing the fast scan trajectory component when entering the region of interest and is designed to increase the angular velocity of fast-scan MEMS mirror 620 when exiting the region of interest.

At 1650, the angular velocity of the second scanning mirror is increased when scanning in the region of interest. In some embodiments, the actions of block 1650 may be performed by modifying the control signals to the slow-scan MEMS mirror. For example, the control logic 140 may modify the drive signal waveform to speed up the mirror's motion in the region of interest. The slow-scan mirror motion trajectory is designed to increase the angular velocity of slow-scan MEMS mirror 610 when entering the region of interest, thereby increasing the slow scan trajectory component when entering the region of interest and is designed to decrease the angular velocity of slow-scan MEMS mirror 610 when exiting the region of interest.

At 1660 a repetition rate of the pulsed beam of laser light is increased when scanning in the region of interest. In some embodiments, the actions of block 1660 may be performed by a laser control logic. For example, the control logic 140 may increase the pulse generation rate of the laser diode when the scanning mirrors are scanning the pulsed laser light beam in the region of interest. The laser module 630 generates laser light pulses in response to a drive signal received from laser driver 340. Laser driver 340 produces the drive signal in response to control signal(s) received from digital logic 330. In some embodiments, the laser light pulses are generated at a higher repetition rate when the scan trajectory is within the region of interest. For example, when the scan trajectory is outside the region of interest, the laser light pulse repetition may take on a first value, and when the scan trajectory is inside the region of interest, the laser light pulse repetition may take on a second value that is higher than the first value. In some embodiments, the increased laser light pulse repetition rate when scanning within the region of interest enhances the resolution and data acquisition in that area.

While for purposes of simplicity of explanation, the respective processes are shown and described as a series of blocks in FIG. 16, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per sc.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A light detection and ranging system comprising:
a laser light source;
at least one light sensitive device;
at least one time-of-flight measurement circuit responsive to the at least one light sensitive device;
a first scanning mirror assembly to scan light received from the laser light source on a trajectory in a field of view, the trajectory including a first trajectory component in a fast-scan direction and a second trajectory component in a slow-scan direction, wherein the field of view includes a region of interest in the field of view, and wherein the second trajectory component speeds up entering the region of interest and slows down exiting the region of interest; and
a second scanning mirror assembly to synchronously scan with the first scanning mirror assembly and deposit reflected light energy from the field of view on the at least one light sensitive device.

2. The light detection and ranging system of claim 1, wherein the light received from the laser light source comprises light pulses having a time difference therebetween, and wherein the time difference is smaller inside the region of interest than outside the region of interest.

3. The light detection and ranging system of claim 1, wherein the laser light source is responsive to a laser light control signal, and wherein the laser light control signal causes the laser light source to increase a laser light pulse repetition rate inside the region of interest.

4. The light detection and ranging system of claim 1, wherein the second trajectory component is slowest at an extents of the field of view.

5. The light detection and ranging system of claim 1, wherein the first trajectory component slows down entering the region of interest and speeds up exiting the region of interest.

6. The light detection and ranging system of claim 1, wherein the light received from the laser light source comprises light pulses having a time difference therebetween, and wherein the time difference is smaller inside the region of interest than outside the region of interest, and wherein the laser light source is responsive to a laser light control signal, and wherein the laser light control signal causes the laser light source to increase a laser light pulse repetition rate inside the region of interest.

7. The light detection and ranging system of claim 1, wherein the first scanning mirror assembly comprises first drive circuitry and a first scanning mirror, wherein the first scanning mirror is responsive to a first drive signal produced by the first drive circuitry to scan the light received from the laser light source in the fast-scan direction and a second drive circuitry and a second scanning mirror, wherein the second scanning mirror is responsive to a second drive signal produced by the second drive circuitry to scan the light received from the laser light source in the slow-scan direction, wherein the first drive circuitry includes a look up table to create the first drive signal.

8. The light detection and ranging system of claim 1, wherein the first scanning mirror assembly comprises first drive circuitry and a first scanning mirror, wherein the first scanning mirror is responsive to a first drive signal produced by the first drive circuitry to scan the light received from the laser light source in the fast-scan direction and a second drive circuitry and a second scanning mirror, wherein the second scanning mirror is responsive to a second drive signal produced by the second drive circuitry to scan the light received from the laser light source in the slow-scan direction, wherein the second drive circuitry includes a look up table to create the second drive signal.

9. The light detection and ranging system of claim 1, wherein the first scanning mirror assembly comprises first drive circuitry and a first scanning mirror, wherein the first scanning mirror is responsive to a first drive signal produced by the first drive circuitry to scan the light received from the laser light source in the fast-scan direction and a second drive circuitry and a second scanning mirror, wherein the second scanning mirror is responsive to a second drive signal produced by the second drive circuitry to scan the light received from the laser light source in the slow-scan direction, wherein the first drive circuitry a circuit to sum harmonics to create the first drive signal.

10. A system comprising:
a laser light source to emit laser light pulses in response to a laser light source control signal;
a first scanning mirror to scan the laser light pulses on a fast-scan axis in a field of view in response to a first scanning mirror control signal;
a second scanning mirror to scan the laser light pulses on a slow-scan axis in the field of view in response to a second scanning mirror control signal; and
a drive circuitry to produce the laser light source control signal, the first scanning mirror control signal, and the second scanning mirror control signal;
wherein the field of view includes a region of interest, and the drive circuitry is configured to slow down the first scanning mirror when scanning in the region of interest.

11. The system of claim 10, wherein the drive circuitry is further configured to increase a laser light pulse repetition rate when scanning in the region of interest.

12. The system of claim 10, wherein the drive circuitry includes at least one look-up table used to produce at least one of the laser light source control signal, the first scanning mirror control signal, and the second scanning mirror control signal.

13. The system of claim 10, wherein the drive circuitry is configured to produce the first scanning mirror control signal as a sum of sinusoids.

14. The system of claim 10, further comprising:
a light sensitive device to receive reflected laser light pulses; and
a time-of-flight measurement circuit coupled to the light sensitive device to determine a time-of-flight of reflected laser light pulses.

15. A method comprising:
producing a pulsed beam of laser light;
scanning the pulsed beam of laser light on a fast-scan axis in a field of view using a first scanning mirror, wherein the field of view includes a region of interest;
scanning the pulsed beam of light on a slow-scan axis in the field of view using a second scanning mirror;
decreasing an angular velocity of the first scanning mirror when scanning in the region of interest; and
increasing a repetition rate of the pulsed beam of laser light when scanning in the region of interest.

16. The method of claim 15, further comprising increasing an angular velocity of the second scanning mirror when scanning in the region of interest.

17. The method of claim 16 wherein the angular velocity of the second scanning mirror is lowest at an extents of the field of view.

18. The method of claim 15, wherein the region of interest is centered in the field of view.

19. The method of claim 15, further comprising:
receiving reflections of the pulsed beam of laser light; and
measuring times-of-flight of the reflections of the pulsed beam of laser light.

20. The method of claim 15, further comprising:
summing a sinusoidal signal with at least one harmonic of the sinusoidal signal to produce a drive signal representing a desired angular velocity of the first scanning mirror; and
driving the first scanning mirror with the drive signal.
